(19) United States
(12) Patent Application Publication
(10) Pub. No.: US 2005/0038911 A1
(43) Pub. Date: Feb. 17, 2005

(54) Cooperative system and method therefor

(76) Inventors: Yoshikuni Watanabe, Yokohama (JP); Nobuhiko Sato, Kawasaki (JP); Makoto Kitagawa, Fujisawa (JP); Tetsuya Hashimoto, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/945,934

(22) Filed: Sep. 22, 2004

Related U.S. Application Data
(63) Continuation of application No. 09/559,060, filed on Apr. 28, 2000.

(30) Foreign Application Priority Data
Apr. 30, 1999 (JP) 11-123508

(51) Int. Cl. G06F 15/16

(52) U.S. Cl. 709/246

(57) ABSTRACT

A cooperative system includes a plurality of information systems and a hub system connected to the plurality of systems. The hub system receives a message from a first information system, determines necessity of message conversion and a kind of conversion, converts the message to a form suitable for a second information system which is destination, only when message conversion is necessary, and transmits the message to a second information system. The hub system may determine whether flow control determining a flow and destination of a message received from the first information system based on a class of the message should be conducted, and conduct flow control only when it has been determined that flow control should be conducted.

### CROSS-REFERENCE TO RELATED APPLICATION

This application relates to U.S. patent application Ser. No. 09/443102 filed on Nov. 18, 1999 and assigned to the present assignee, and U.S. patent application Ser. No. ______ being filed on ______ based on Japanese Application Serial No. 11-070623 filed on Mar. 16, 1999 and assigned to the present assignee. The contents of those applications are incorporated herein by reference.

### BACKGROUND OF THE INVENTION

The present invention relates to an inter-system cooperative system for implementing functional cooperation among a plurality of information systems, and a method therefor.

Heretofore, information systems corresponding to various kinds of business have been developed and put to practical use. In recent years, attempts for implementing a wide variety of services by making those existing information systems cooperate have been made.

FIG. 10 shows an example of conventional cooperation among information systems. A teller system 1001 is a system to be used when conducting various kinds of teller business in a teller shop. An accounting system 1002 is a system to be used in a bank when giving services concerning giving and taking of money. An investment trust system 1003 is a system to be used in a securities company when giving services concerning investment trust. For example, it is now assumed that giving and taking of money has occurred in the teller system 1001. In order to transmit its information from the teller system 1001 to the accounting system 1002 and automatically conduct the giving and taking of money between predetermined accounts, it is necessary to connect the teller system 1001 to the accounting system 1002 and make them operate in cooperation. Furthermore, in order to introduce an Internet banking system 1004, connect each customer at a client 1005 to the Internet banking system 1004 via Internet 1006, and provide each customer with various kinds of bank service, it is necessary to connect the Internet banking system 1004 to the accounting system of a bank and make them operate in cooperation.

When connecting information systems and making them cooperative as heretofore described, individual coping has heretofore been conducted. In other words, information systems to be made cooperative are individually subjected to alteration (such as function addition) to become cooperative. However, there are a great variety of kinds of information systems, and the number of their connection combinations is also very large. In such a scheme that systems to be made cooperative are individually altered, the development is troublesome and rapid inexpensive diversification is difficult. Furthermore, if a system cooperating with a plurality of other systems, such as the accounting system 1002 of FIG. 10 is altered, then other systems are largely affected and it is also considered that coordination cannot be effected among systems.

In recent years, therefore, there has been proposed such a scheme that various information systems are connected to a system having functions of route control and message conversion and serving as a core and systems are made cooperative via the system serving as the core. Such a scheme is called hub and spoke, and the core portion is called hub. The configuration of the hub and spoke is disclosed in U.S. Pat. No. 5,193,056, Boes as well.

FIG. 11 shows a connection example in the hub and spoke. A teller system 1102, an Internet banking system 1103, a call center system 1104, an investment trust system 1105, a CRM (customer relationship management) system 1106, an accounting system 1107, and so on are connected to a hub 1101. The teller system 1102, the Internet banking system 1103, the investment trust system 1105, and the accounting system 1107 are similar to the systems 1001 to 1004 described with reference to FIG. 10. The call center system 1104 is a system of a so-called call center in which, for example, a toll-free telephone call originated by a customer is received by an operator and the operator operates the terminal to conduct various kinds of business in response to a request from the customer. The CRM system 1106 is a system for managing relations with customers. For example, commodities purchased by each customer in the past are stored in a DB (data base), and an optimum commodity is proposed according to the purchase situations. In this way, the CRM system 1106 is a management system for building one-to-one proper relations with each customer.

By connecting the systems 1102 to 1107 to the hub 1101, they can cooperate with each other without being conscious of other systems. For example, a message used by the teller system 1102 to request another system to do business is first input to the hub 1101. The hub 1101 passes a judgment on the opposite party system to which the message should be sent. The hub 1101 converts the message into a message having a protocol and a message form conforming to the opposite party system, and sends a resultant message to the opposite party. Since a difference between systems is thus absorbed by the hub 1101, cooperation becomes easy by connecting systems to the hub 1101. When constructing a new service, cooperation of systems can be easily implemented by defining a processing procedure for making the systems cooperative in the hub, without conducting alterations on the systems (or with conducting slight alterations concerning the user interface on the systems).

For example, when an individual buys the investment trust commodity, typically there is needed such an operation that the individual withdraws money from the individual's saving account (withdraws money in the accounting system) and deposits the money in the investment trust system (sends the money to the investment trust system and buys the investment trust commodity). However, such processing extending over a plurality of systems can be defined in the hub easily. As a result, composite service through a teller shop and the Internet can be implemented. Also when the configuration of the system and the pattern of the cooperation are to be altered, it can be coped with by altering the definition stored in the hub. Alteration of one system exerts little influence upon other systems.

Whatever message may be input to the above described conventional hub, the conventional hub determines a route, conducts protocol conversion and message conversion, and transfers a result to the opposite party system. This results in a problem that the duration of the message communication and the response time taken until an answer message is obtained are prolonged.

### SUMMARY OF THE INVENTION

An object of the present invention is to shorten the duration of the message communication through the hub and the response time taken until an answer message is obtained, in a “hub and spoke” system for implementing function cooperation among a plurality of information systems.

In order to achieve this object, a cooperative system includes a plurality of information systems and a hub system connected to the plurality of systems. The hub system receives a message from a first information system, determines necessity of message conversion and a kind of conversion, converts the message to a form suitable for a second information system which is destination, only when it has been determined that message conversion is necessary, and transmits the message to a second information system. The hub system may determine whether flow control determining a flow and destination of a message received from the first information system based on a class of the message should be conducted, and conduct flow control only when it has been determined that flow control should be conducted.

### BRIEF DESCRIPTION OF THE DRAWINGS

FIG. 1 is a schematic diagram of a “hub and spoke” system of an embodiment of the present invention;

FIG. 2 is a schematic diagram of an execution environment of the “hub and spoke” system;

FIG. 3 is a diagram showing a system configuration example of a hub;

FIG. 4 is a diagram showing an internal configuration of an adapter;

FIGS. 5A, 5B and 5C are diagrams showing three paths;

FIG. 6 is a processing flow diagram of a client side adapter;

FIG. 7 is a processing flow diagram of a server side adapter which receives a message via a specific protocol direct connection path;

FIG. 8 is a processing flow diagram of a server side adapter which receives a message via an adapter direct connection path or a normal path;

FIG. 9 is a diagram showing an example of a message given and received in the present embodiment;

FIG. 10 is a diagram showing an example of conventional cooperation among information systems;

FIG. 11 is a diagram showing a connection example in a conventional “hub and spoke”;

FIG. 12 is a processing flow diagram for determining a path on the basis of a business code and a protocol;

FIG. 13 is a processing flow diagram for determining a path on the basis of an amount of money of deposit;

FIG. 14 is a diagram showing an example of association of connection systems with paths to be used;

FIG. 15 is a processing flow diagram in the case where a path is determined on the basis of a connected system;

FIG. 16 is a diagram showing an example of association of user classes with paths to be used; and

FIG. 17 is a processing flow diagram in the case where a path is determined on the basis of a user class.

### DESCRIPTION OF THE EMBODIMENTS

(1) System Summary

Hereafter, an embodiment of the present invention will be described by referring to drawing.

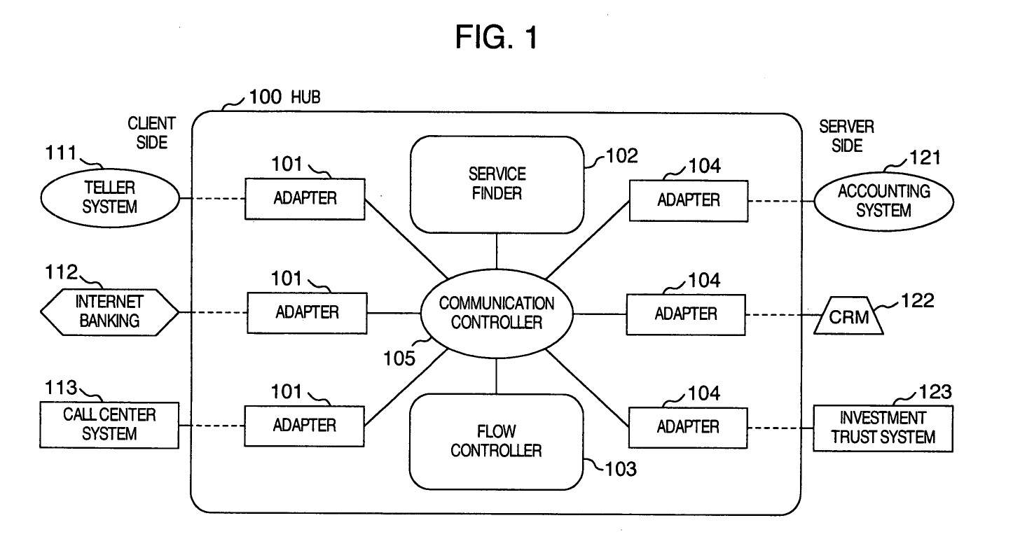

FIG. 1 schematically shows a “hub and spoke” system. As information systems of client side, a teller system 111, an Internet banking system 112, and a call center system 113 are connected to a hub 100. As information systems of server side, an accounting system 121, a CRM system 122, and an investment trust system 123 are connected to the hub 100. These systems 111 to 113 and 121 to 123 are information systems for performing various kinds of business similar to those described in “BACKGROUND OF THE INVENTION.” Each of the systems is connected to the hub via a network such as a WAN or the Internet. The hub 100 includes one or more computers. The function of the hub is implemented by software executed by the computer(s).

The hub 100 includes client side adapters 101, a service finder 102, a flow controller (or flow controllers) 103, and server side adapters 104. These components basically exchange messages with each other via a communication controller 105 which is formed according to CORBA (Common Object Request Broker Architecture) specifications, which provides a distributed object environment. The CORBA is the name of a distributed processing environment architecture advocated by Object Management Group. As a protocol according to the CORBA specifications used in the hub, IIOP (Internet inter-ORB protocol) is well known.

The client side adapters 101 are provided so as to be associated with respective client side systems. Each of the client side adapters 101 has functions of channel I/F (interface) control between the client side adapter and the client side system, protocol conversion between a protocol of the client side system and a protocol of CORBA specifications in the hub, and message conversion between a message form of the client side system and a message form of a server side system which is the destination of the message.

The adapter 101 may be provided for each protocol. Otherwise, one adapter may be associated with all systems.

The server side adapters 104 may be provided so as to be associated with respective server side systems. Each of the server side adapters 104 has functions of server I/F control between the server side adapter and the server side system, connection to a legacy system utilizing a wrapper, protocol conversion between a protocol of the server side system and a protocol of CORBA specifications in the hub, and message conversion between a message form in the hub and a message form of the server side system.

The adapter 104 may be provided for each protocol. Otherwise one adapter may be associated with all systems.

The service finder 102 manages message routing information. For example, when acquiring the destination of a message received by the client side adapter 101 or the flow controller 103, the service finder 102 is inquired of about the destination. The flow controller 103 provides composite service utilizing work management. In other words, when conducting cooperative processing in a plurality of servers in response to a message received by a client side adapter 101, the flow controller 103 controls the flow of messages, i.e., controls which server side adapter 104 the message should be transmitted to in which order. Such control may be accomplished by a plurality of flow controllers, each controller controlling a flow for one cooperative service.

(2) Route of Message

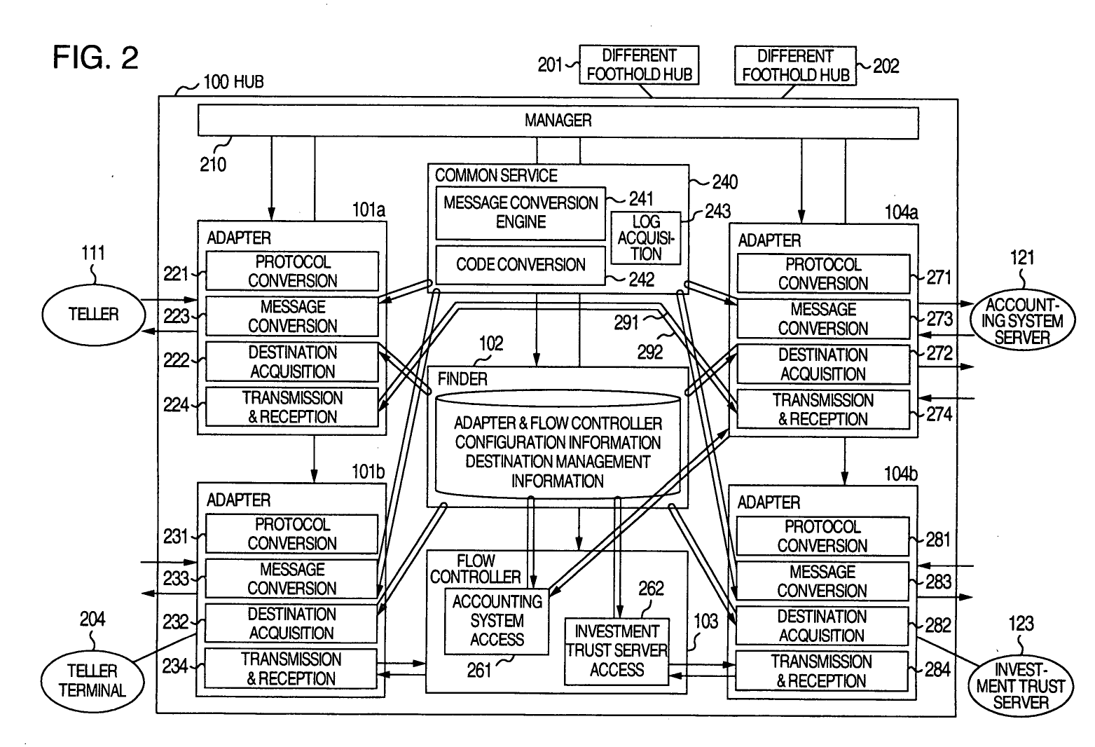

FIG. 2 schematically shows an execution environment of the “hub and spoke” system. Out of the system summary of FIG. 1, FIG. 2 shows the software configuration of the hub 100 and data flow in more detail. In FIG. 2, the teller system 111 and a teller terminal 204 are connected to the hub 100 as client side systems. As server side systems, the accounting system 121 and the investment trust system 123 are connected to the hub 100. The teller terminal 204 is a so-called window terminal. The teller terminal 204 is a terminal for an operator to input various kinds of information at a teller window or a call center in response to a customer's request. Hubs 201 and 202 having different footholds are connected to the hub 100. A manager 210 conducts operation management, system configuration management, and log acquisition specification control on various components in the hub 100.

A message transmitted from the client side system 111 or 204 is transmitted to the server side system 121 or 123 via the hub 100. As message routes (paths), three paths are prepared in the hub 100. The three paths are a normal path, an adapter direct connection path, and a specific protocol direct connection path.

The path to be used is determined by each adapter on the basis of the received message. A method for determining the path will be described later.

(2-A) Normal Path

The normal path will now be described. An adapter 101b is an adapter associated with the teller terminal 204. A message transmitted from the teller terminal 204 is received by the adapter 101b. The adapter 101b converts the protocol of the message to a protocol in the hub by using a protocol conversion function 231. The adapter 101b then inquires of the service finder 102 the destination of the message by utilizing a destination acquisition (destination inquiry) function 232. The service finder 102 manages configuration information of adapters 101a, 101b, 104a, and 104b, and the flow controller 103, and management information of a message destination system. In the case of the normal path, the service finder 102 orders transmission of the message to the flow controller 103. Upon receiving the message, the adapter 101b conducts message conversion by using a message conversion function 233 as occasion demands, and transmits the message to the flow controller 103 by using a intra-hub message transmission and reception function 234. In the case where the adapter 101b conducts message conversion, the adapter 101b utilizes a message conversion engine 241 and a code conversion engine 242 of a common service 240. As for processing conducted in the hub 100, the processing history is recorded as a log by using a log acquisition function 243.

Methods of the message conversion and the protocol conversion are described in U.S. Pat. No. 5,187,787, Skeen et al., U.S. Pat. No. 5,257,369, Skeen et al., and U.S. Pat. No. 5,557,798, Skeen et al.

According to the received message, the flow controller 103 accesses some server side systems one after another in accordance with a determined flow, and conducts processing according to the message. The flow controller 103 determines a server side system to be accessed by inquiring of the service finder 102 and utilizing its management information. The flow controller 103 first accesses the accounting system 121 and conducts predetermined processing (261), and then accesses the investment trust system 123 and conducts predetermined processing (262). In the access (261) to the accounting system 121, the flow controller 103 sends a predetermined message to the adapter 104a associated with the accounting system 121, and obtains an answer message therefor. Thereafter, in the access (262) to the investment trust system 123, the flow controller 103 sends a predetermined message to the adapter 104b associated with the investment trust system 123, and obtains an answer message therefor. The flow controller 103 processes the obtained answer message as occasion demands, and returns a resultant message to the original adapter 101b. The adapter 101b conducts necessary processing such as protocol conversion and message conversion, and returns an answer message to the associated teller terminal 204.

The message transmitted from the flow controller 103 by the access processing (261) to the accounting system 121 is received by an intra-hub message transmission and reception function 274 of the adapter 104a associated with the accounting system 121. The adapter 104a converts the protocol of the message from the protocol in the hub to a protocol of the accounting system 205. As occasion demands, the adapter 104a then conducts message conversion by using a message conversion function 273. The adapter 104a then transmits the message to the accounting system 121. According to the received message, the accounting system 121 conducts predetermined business processing. The accounting system 121 then generates an answer message, and returns it to the adapter 104a. The adapter 104a receives the answer message, converts the protocol of the answer message to the protocol in the hub by using the protocol conversion function 271, and inquires of the service finder 102 the destination of the answer message by using a destination acquisition function 272. (The adapter 104a may store the massage source information in the memory when receiving the message, and use the information as the answer message destination.) Here, the destination is the flow controller 103. As occasion demands, the adapter 104a conducts message conversion by using the message conversion function 273. By using the message transmission and reception function 274, the adapter 104a sends the answer message to the flow controller 103 which is the request issuing source.

A message transmitted by the processing of accessing the investment trust system 123 (262) is received by the adapter 104b associated with the investment trust system 123. Processing conducted in the adapter 104 is similar to that conducted in the adapter 104a, and consequently its description will be omitted.

As heretofore described, in the normal path, a message issued by a client side system is subjected in a client side adapter to required conversion such as protocol conversion, and delivered to the flow controller. In a predetermined flow, the flow controller accesses a server side system via a server side adapter, and advances business processing. Between the client side and server side adapters and the flow controller, message transmission and reception are conducted by using the protocol in the hub (according to the CORBA specifications).

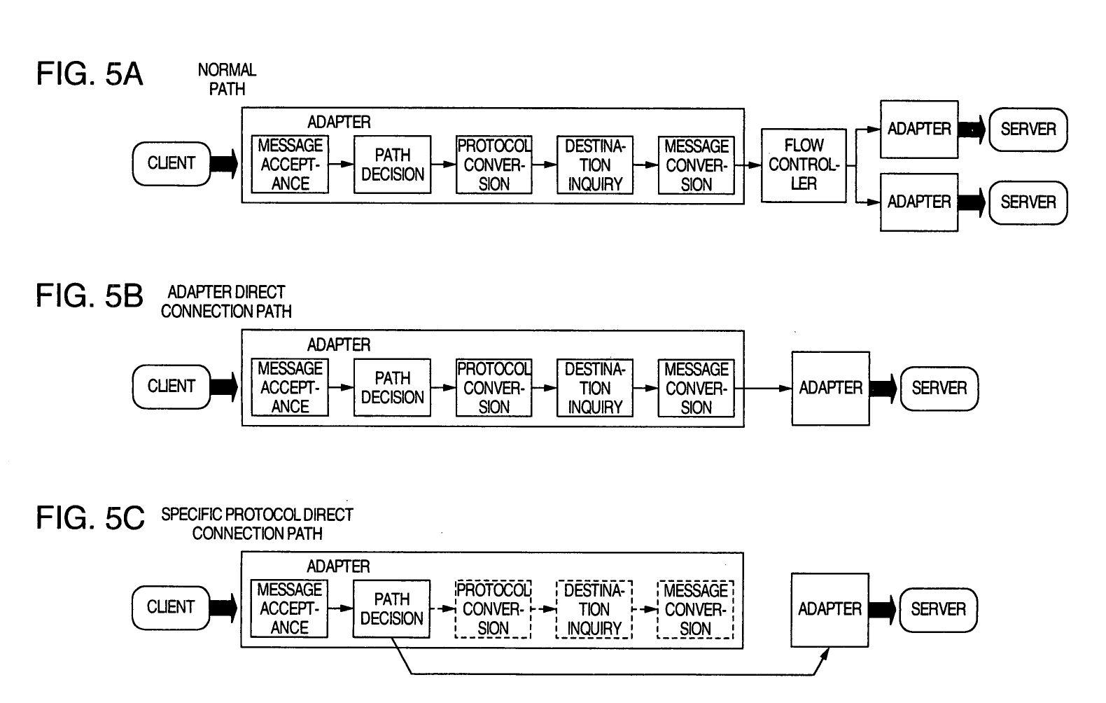

The flow of control from the client to the server heretofore described is shown in FIG. 5A.

(2-B) Adapter Direct Connection Path

The adapter direct connection path will now be described by referring to FIG. 2. In the above described normal path, the flow controller can conduct processing with a plurality of servers made cooperative. In the case where the flow control is not required, however, a message can be sent from a client side adapter directly to a server side adapter by using the adapter direct connection path, without intervention of the flow controller. By taking the case where a message is to be sent from the teller system 111 to the accounting system 121 as an example, the adapter direct connection path will be described hereafter. It is now assumed that a protocol used in the teller system 111 is different from a protocol used in the accounting system 121.

The adapter 101a is an adapter associated with the teller system 111. A message transmitted from the teller system 111 is received by the adapter 101a. The adapter 101a converts a protocol of the message to the protocol in the hub by using a protocol conversion function 221, and inquires of the service finder 102 the destination of the message by using a destination acquisition (destination inquiry) function 222. In the case of the adapter direct connection path, the service finder 102 returns indication of an adapter of a server side system to which the message should be directly sent, as the destination of the message. Here, the adapter 104a of the accounting system 121 is indicated as the destination. Upon receiving this, the adapter 101a conducts message conversion by using a message conversion function 223 as occasion demands, and sends the message to the adapter 104a associated with the accounting system 121 by using an intra-hub message transmission and reception function 224. Processing conducted in the adapter 104a is the same as that described with reference to the normal path. However, an answer message is returned from the adapter 104a directly to the adapter 101a. Arrows 291 and 292 of FIG. 2 show message flows on the adapter direct connection path.

As heretofore described, on the adapter direct connection path, a message issued by a client side adapter is transmitted directly to a server side adapter, and the message is not passed through the flow controller 103. As compared with the normal path, therefore, the communication speed is fast and the response is also fast. On the above described adapter direct connection path, the client side adapter 101a converts the protocol of the client side system 111 to the protocol in the hub (according to the CORBA specifications), and the server side 104a converts the protocol in the hub to the protocol of the server side system 121. Instead of conducting such protocol conversion, the client side adapter 104a may convert the protocol of the client side system 111 to the protocol of the server side system 121, and send the message directly without intervention of the protocol in the hub. Since intervention of the protocol in the hub is thus obviated, communication can be conducted faster by that amount.

The flow of control from the client to the server heretofore described is shown in FIG. 5B.

(2-C) Specific Protocol Direct Connection Path

The specific protocol direct connection path will now be described by referring to FIG. 2. On the above described adapter direct connection path, protocol conversion is indispensable because the protocol of the client side is different from that of the server side. In the case where the protocol of the client side is the same as the protocol of the server side, however, a message can be sent from a client side adapter directly to a server side adapter via the specific protocol direct connection path, without conducting protocol conversion. Hereafter, by taking the case where a message is sent from the teller system 111 to the accounting system 121 as an example, the specific protocol direct connection path will be described. It is now assumed that a protocol used in the teller system 111 is the same as a protocol used in the accounting system 121.

A message transmitted from the teller system 111 is received by the adapter 101a. The adapter 101a transmits the message directly to the adapter 104a. The adapter 104a receives the message. The adapter 104a transmits the received message to accounting system 121. An answer message is also returned via the specific protocol direct connection path in the same way.

As heretofore described, on the specific protocol direct connection path, a message issued by a client side adapter is transmitted directly to a server side adapter, and protocol conversion is not required. In other words, communication is not conducted by using intra-hub message transmission and reception functions 224 and 274 for exchanging messages according to the CORBA, but communication is conducted directly with the protocol used in the teller system 111 and the accounting system 121. As compared with the adapter direct connection path, therefore, the communication speed is further faster and the response is also fast. By the way, message conversion may be conducted in either a client side adapter 101a or 101b, or a server side adapter 104a or 104b, as occasion demands.

The flow of control from the client to the server heretofore described is shown in FIG. 5C.

(3) Determination of Path

In (2), three paths have been described. A method for determining the path will now be described.

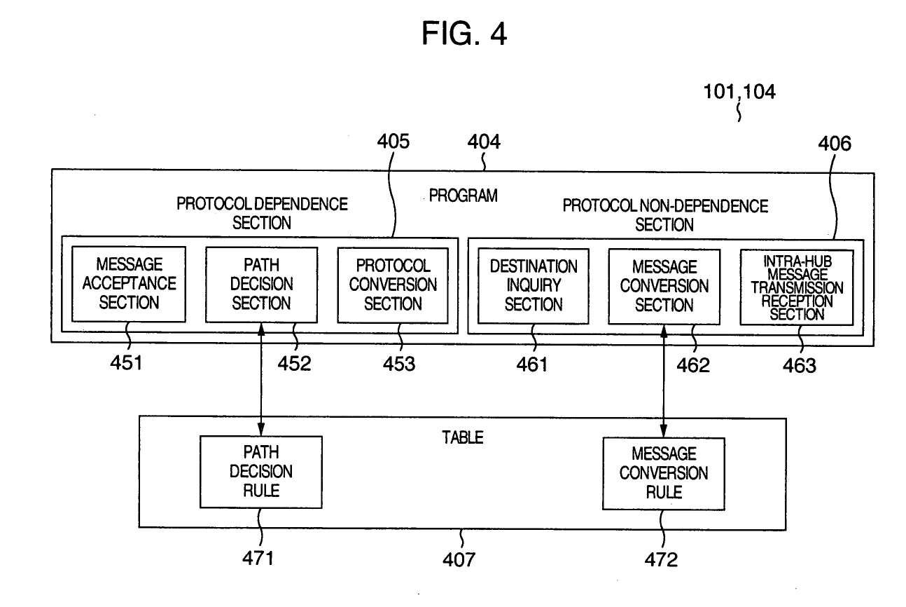

FIG. 4 shows an example of adapter software. The client side adapters have the same configuration as the server side adapters. Each adapter is a function (program) mounted on an arbitrary computer included in the hub. Each adapter includes a program 404 and a table 407.

The program 404 is divided into a protocol dependence section 405 and a protocol non-dependence section 406. The protocol dependence section 405 includes a message acceptance section 451, a path decision section 452, and a protocol conversion section 453. The protocol non-dependence section 406 includes a destination inquiry (destination acquisition) section 461, a message conversion section 462, and an intra-hub message transmission and reception section 463.

The message acceptance section 451 of the protocol dependence section 405 conducts acceptance processing of a message issued by the protocol of a client side or server side system associated with this adapter. According to the accepted message, the path decision section 452 determines which of the normal path, the adapter direct connection path, and the specific protocol direct connection path should be utilized, on the basis of a path decision rule 471. The protocol conversion section 453 (corresponding to 221, 231, 271, and 281 of FIG. 2) conducts conversion between the protocol of the client side or server side system and the protocol of the CORBA specifications in the hub. The above described sections 451 to 453 are sections which need processing depending on the protocol of a client side or server side system associated with this adapter.

The destination inquiry section 461 (corresponding to 222, 232, 272, and 282 of FIG. 2) of the protocol non-dependence section 406 conducts processing of inquiring of the service finder the destination of a message. On the basis of a message conversion rule 472, the message conversion section 462 conducts conversion of the message form between a message form of a client side system and a message form of a client side system. Since the message conversion can be conducted in an arbitrary position between the client and the server, it is sufficient that the message conversion section 462 is provided in either the client side adapters or the server side adapters. In some cases, the term “protocol” refers to not only the communication procedure in a physical layer but also conversion of the message form between systems, as a whole. However, it is now assumed that the term “protocol” does not include conversion of the message form. The intra-hub message transmission and reception section 463 conducts message transmission and reception according to the protocol of the CORBA specifications in the hub. The sections 461 to 463 heretofore described are sections for conducting processing which does not depend upon the protocol of the client side or server side system associated with the adapter. The sections 461 to 463 are sections which operate on the CORBA.

The sections heretofore described correspond to the functions of FIGS. 5A to 5C.

FIG. 9 shows an example of a message given and received in the present embodiment. The message includes control information 901, a business code 902, and business specific information 903. The control information 901 is control information representing the source and destination of the message, message class, or data length and form. The business code 902 is code information representing what kind of business the message requests. The business specific information 903 is information specific to the requested business.

The control information 901 may include a path decision result conducted by the adapter and a flag indicating whether message conversion has already been conducted. (These kinds of information may be transmitted between programs in the hub by an internal protocol of the hub.)

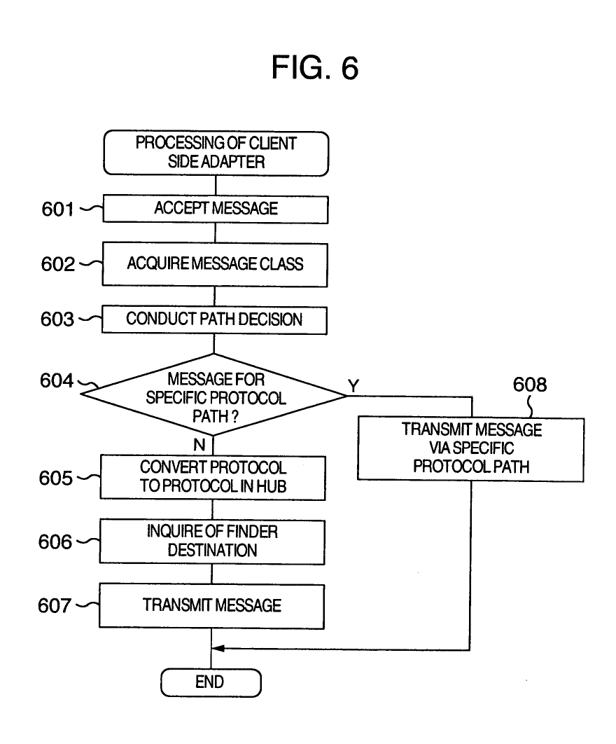

FIG. 6 shows the processing flow of a client side adapter. Upon accepting a message from a client side system at step 601, the client side adapter acquires the class of the message at step 602. At step 603, the client side adapter conducts a path decision and may write a result into a control information field of the message. At this time, the client side adapter may refer to the path decision rule 471 of FIG. 4. Subsequently, at step 604, the client side adapter determines whether the message is a message for specific protocol direct connection path. When the message is not a message for specific protocol direct connection path, the client side adapter converts its protocol to the protocol of the CORBA specifications which is being used in the hub at step 605, and inquires of the service finder the destination at step 606. Upon acquiring the destination from the service finder, the client side adapter transmits the message to its destination, i.e., to the flow controller or server side adapter at step 607, and finishes the processing. No matter whether the destination is a server side adapter of the adapter direct connection path or the flow controller of the normal path, processing except the destination remains unchanged in the client side adapter. The client side adapter conducts only processing of transmitting the message to the destination acquired from the service finder. When it is determined that the message is a message for the specific protocol direct connection path at the step 604, the client side adapter transmits the message via the specific protocol direct connection path at step 608 and finishes the processing.

The path decision will now be described in detail by citing a plurality of examples.

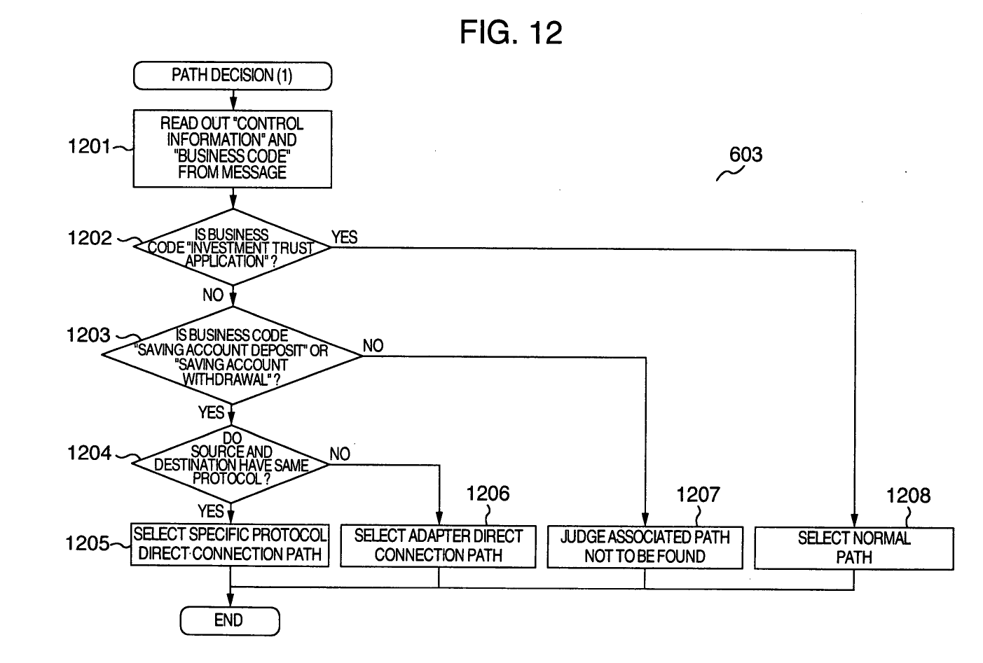

In the processing flow of the client side adapter of FIG. 6, the path decision of the step 603 is conducted on the basis of the control information 901 and the business code 902 of FIG. 9. FIG. 12 shows an example of a processing flow of the path decision. At step 1201, the control information 901 and the business code 902 are read out from the message. At step 1202, it is determined whether the business code 902 is “investment trust application.” If so, the normal path is selected as a decision result at step 1208. Otherwise, it is determined at step 1203 whether the business code 902 is “saving account deposit” or “saving account withdrawal.” If neither of them is the case, then it is judged at step 1207 that the associated path has not been found. If the business code 902 is either “saving account deposit” or “saving account withdrawal,” then it is determined at step 1204 whether the source and the destination have the same protocol. In the case of the same protocol, the specific protocol direct connection path is selected at step 1205. If the source and the destination do not have the same protocol, the adapter direct connection path is selected at step 1206.

Relations between business codes and paths may be defined in a table form as the path decision rule 471. Further, information representing protocols used by respective systems (source and destination) is also stored in the path decision rule.

As a variation of FIG. 12, an example in which a path is determined according to the source and content of a message will now be described. In other words, the specific protocol direct connection path or the adapter direct connection path is provided as a specific path for special cases. All other cases are processed with the normal path. Although it depends on a message and a system configuration handled by the system, there is a possibility that the load converges on a part of the system in the case of the specific protocol direct connection path and the adapter direct connection path. Therefore, the use of the specific protocol direct connection path and the adapter direct connection path can be limited to the special cases.

For example, when the business code is “saving account deposit,” the amount of money of deposit is set as business specific information. Therefore, it is possible to conduct a path decision depending on its amount of money. For example, the specific protocol direct connection path is used when the amount of money is at least a predetermined value, whereas the normal path is used when the amount of money is less than the predetermined value.

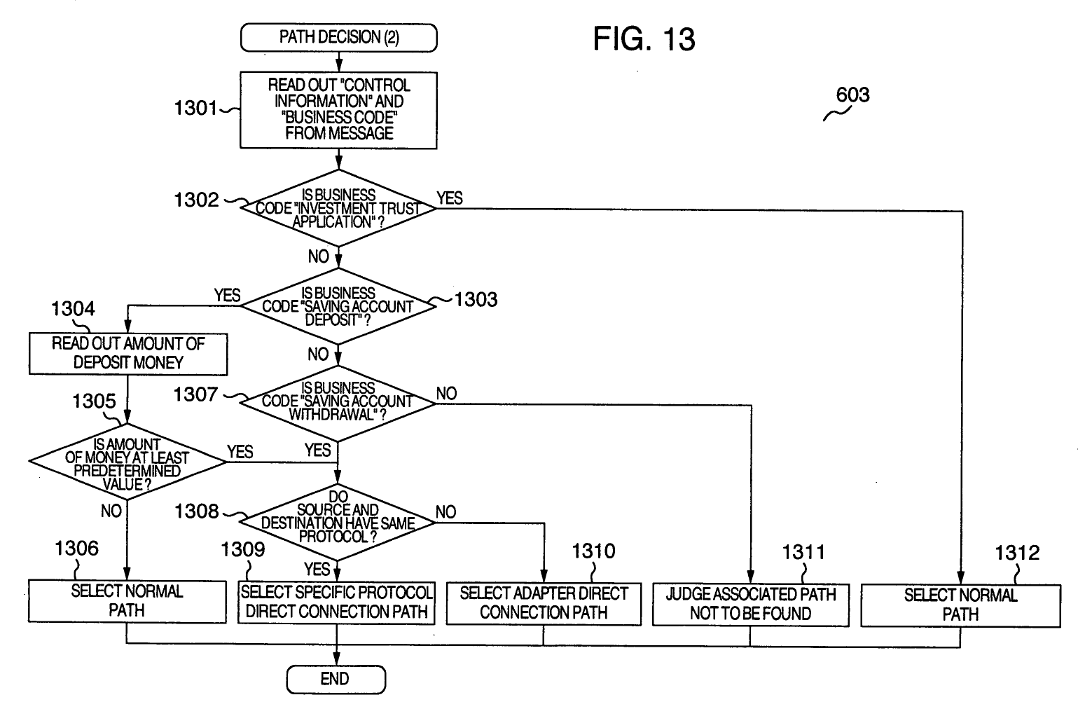

FIG. 13 shows a path decision flow depending on the amount of deposit money of a saving account. At step 1301, the control information 901 and the business code 902 are read out from the message. At step 1302, it is determined whether the business code 902 is “investment trust application”. If so, the normal path is selected as a decision result at step 1312. Otherwise, it is determined at step 1303 whether the business code 902 is “saving account deposit”. If so, then an amount of deposit money in the message is read out at step 1304, and the amount of money is compared with a predetermined value at step 1305. If the amount of money is less than the predetermined value, then the normal path is selected at step 1306. If the amount of money is at least the predetermined value, then the processing proceeds to step 1308. If the business code is not “saving account deposit” at step 1303, then it is determined at step 1307 whether the business code is “saving account withdrawal”. If the business code is not “saving account withdrawal”, then it is judged at step 1311 that the associated path has not been found. If the business code 902 is “saving account withdrawal”, then it is determined at step 1308 whether the source and the destination have the same protocol. In the case of the same protocol, the specific protocol direct connection path is selected at step 1309. If the source and the destination do not have the same protocol, the adapter direct connection path is selected at step 1310.

At the step 1305, the following additional service may be provided. If the amount of money is less than a predetermined value at the step 1305, then on the contrary the specific protocol direct connection is used to conduct a simple service. If the amount of money is at least the predetermined value, then the normal path is used to put an advertisement on the client side and/or access such a system as to activate a customer analysis system.

Furthermore, it is also possible to change the path to be used, according to the kind of a channel which accesses an adapter. This method is effective to the case where it is desirable to conduct especially processing from a specific channel at high speed, such as a teller terminal. For example, it is possible to pass only processing from a specific channel through the specific protocol direct connection path, and pass the same request from other channels through the normal path. By doing so, the load of the specific protocol direct connection path can be lowered. As a result, processing on the specific protocol direct connection path can be executed at higher speed.

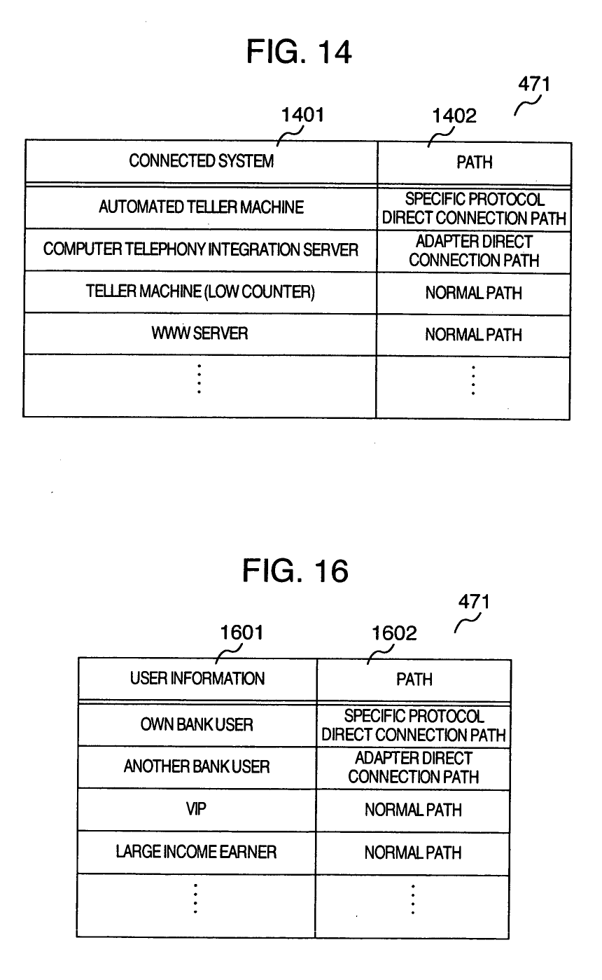

FIG. 14 shows an example of a table indicating paths of respective channels. A field of a system 1401 connected by the adapter indicates a channel which accesses the adapter. A field of a path 1402 indicates the path used to process a request from a channel indicated by the field 1401. For example, it is indicated that a request from an adapter for automated teller machine is processed via the specific protocol direct connection path. This table is stored as a part of the path decision rule.

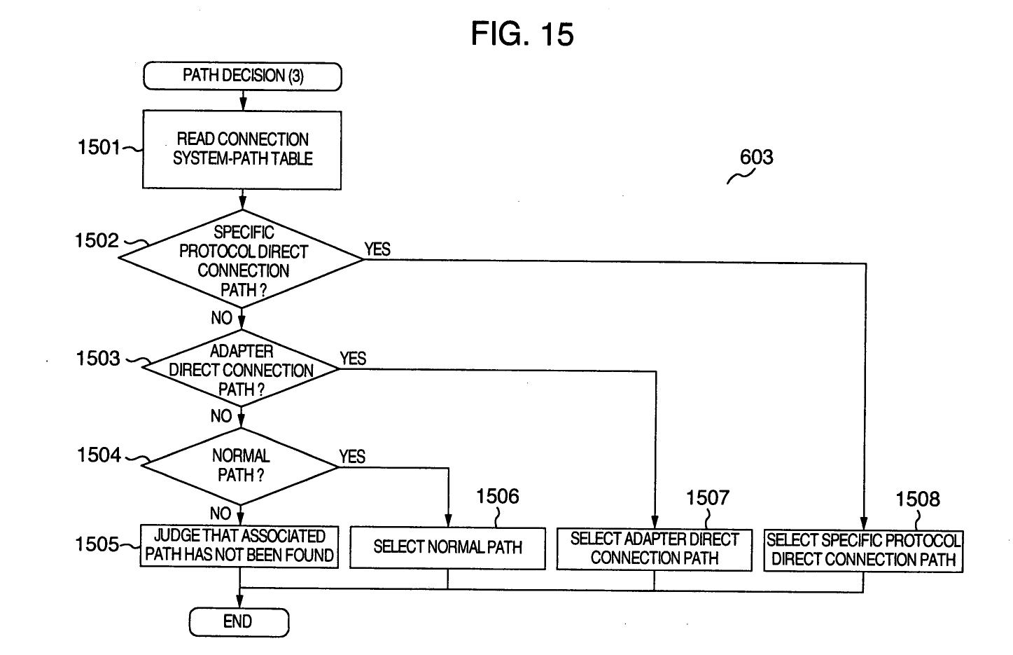

FIG. 15 shows the processing flow in the case where the path to be used is changed according to the channel. At step 1501, the adapter reads out a path associated with a requested channel from the table shown in FIG. 14. For example, upon receiving a request from an automated teller machine, the adapter acquires a record corresponding to the automated teller machine from the field 1401 of the table of FIG. 14, and reads out a value of the path field 1402. At step 1502, it is determined whether the value of the path 1402 indicates the specific protocol direct connection path. If so, the specific protocol direct connection path is selected at step 1508. If the path is not the specific protocol direct connection path, then it is determined at step 1503 whether the path is the adapter direct connection path. If so, the adapter direct connection path is selected at step 1507. If the path is not the adapter direct connection path, it is determined at step 1504 whether the path is the normal path. If so, the normal path is selected at step 1506. Otherwise, it is judged at step 1505 that the associated path has not been found.

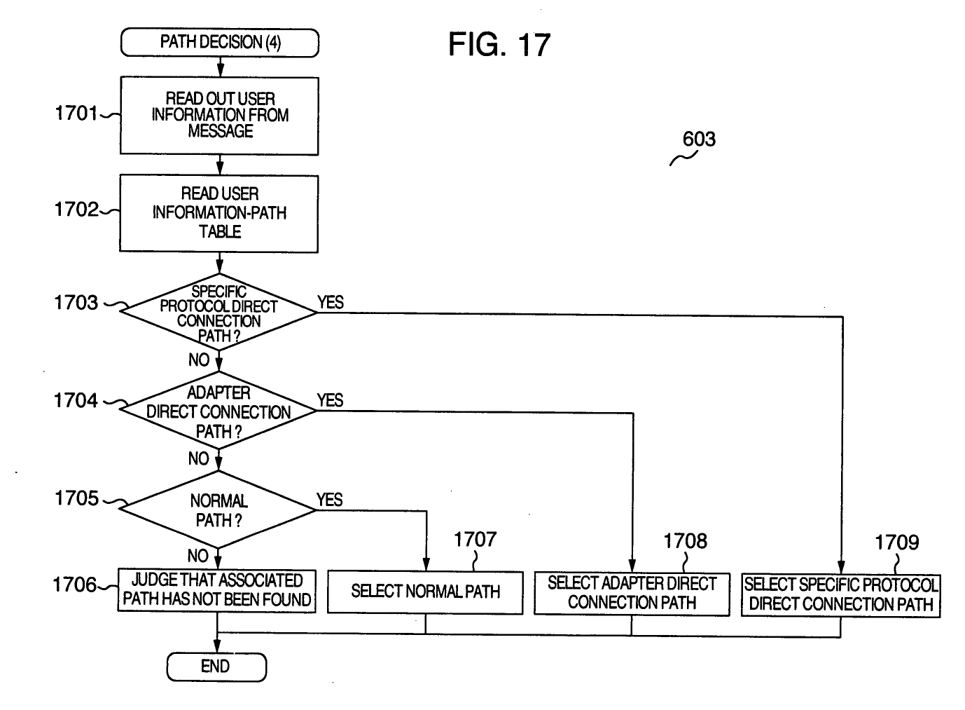

Furthermore, by using user information in the path decision rule, processing from a specific customer can be processed at high speed. For example, only requests from excellent customers can be processed by using the specific protocol direct connection path. FIG. 16 shows an example of a table indicating association of user information with paths. A field of user information 1601 indicates user classes. For example, the user information field 1601 indicates a class such as an own bank user, another bank user, or a large income earner. The path field 1602 indicates a path to be used for each user class. For example, the own bank user can be set so as to use the specific protocol direct connection path. FIG. 17 shows a processing flow in the case where the path to be used is changed according to the user information. At step 1701, user information is read out from a message, and the user class is judged. At step 1702, a path associated with the user class is read out from the table of FIG. 16. For example, if the user is an own bank user, then a record corresponding to the own bank user is acquired from the user information field 1601, and a value of the path field 1602 is read out. At step 1703, it is determined whether the value of the path field 1602 indicates the specific protocol direct connection path. If so, the specific protocol direct connection path is selected at step 1709. If the value of the path field 1602 does not indicate the specific protocol direct connection path, then it is determined at step 1704 whether the path is the adapter direct connection path. If so, the adapter direct connection path is selected at step 1708. If the path is not the adapter direct connection path, it is determined at step 1705 whether the path is the normal path. If so, the normal path is selected at step 1707. Otherwise, it is judged at step 1706 that the associated path has not been found.

The rule of such a path decision is set in the path decision rule 471 of FIG. 4 beforehand.

Processing of a server side adapter will now be described. By, for example, checking the control information 901 of a received message, the adapter can know the path via which the message has been transmitted.

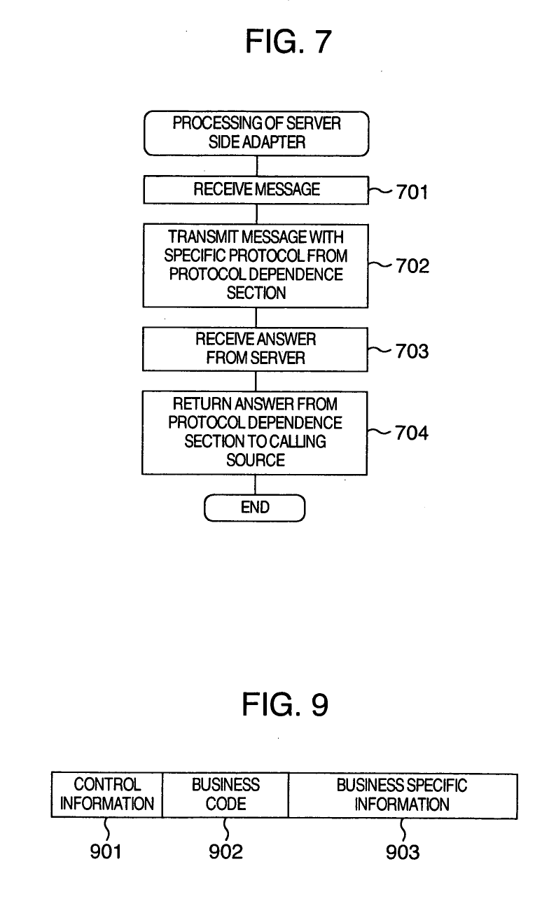

FIG. 7 shows a processing flow of a server side adapter which receives a message via the specific protocol direct connection path. At step 701, a message is received. Namely, the message is received by the dependence section (405 of FIG. 4) which conducts processing depending upon a specific protocol which is a protocol specific to a client or a server. At step 702, the dependence section transmits the message to a server side system by using the specific protocol. If an answer message representing a result of business processing is returned from the server side system, the answer message is received at step 703. At step 704, the dependence section returns the answer message to a client side adapter of the calling source. The processing is thus finished. FIG. 7 shows the case where message conversion is not conducted. When message conversion is required, however, the message conversion may be conducted in the processing of FIG. 7.

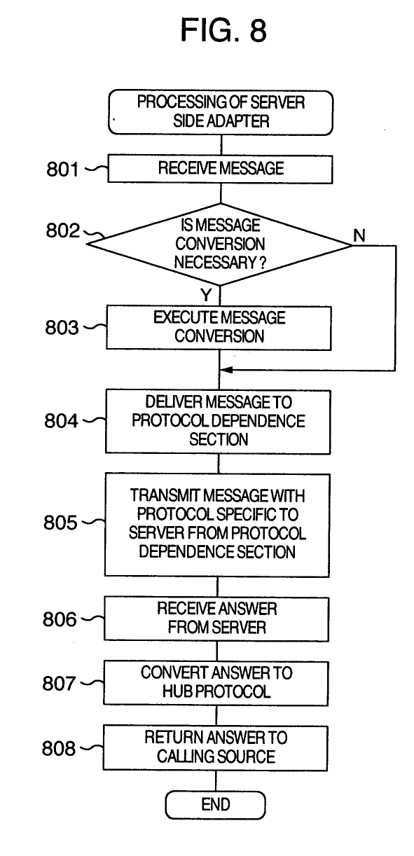

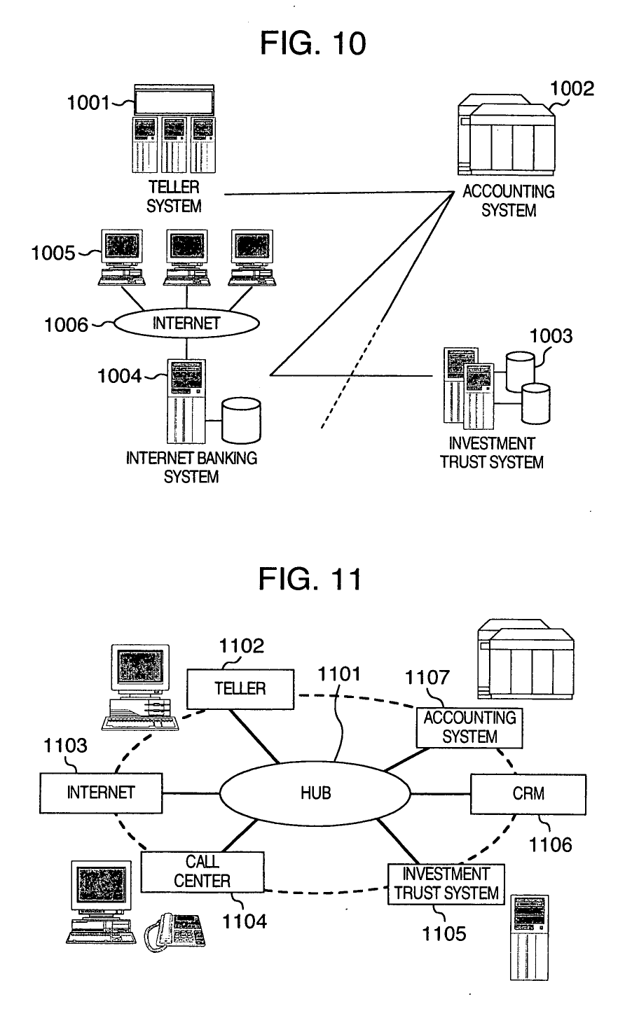

FIG. 8 shows a processing flow of a server side adapter which receives a message via the adapter direct connection path or the normal path. At step 801, a message is received. This is processing of receiving a message by using the protocol of the CORBA specifications which is being used in the hub. This is reception of a message conducted by the intra-hub message transmission and reception section 463 of the non-dependence section 406 shown in FIG. 4. Subsequently, at step 802, it is determined on the basis of the message class and the flag in the message whether message conversion is necessary. If necessary, the message conversion is conducted at step 803. Subsequently, at step 804, the message is delivered from the non-dependence section to the dependence section (405 of FIG. 4). At step 805, the dependence section converts the protocol to a protocol specific to the server, and transmits the message to the server side system. If an answer message representing a result of business processing is returned from the server side system, the answer message is received at step 806. At step 807, the dependence section converts the answer message to a message having the protocol of the CORBA specifications in the hub. At step 808, the non-dependence section returns the answer message to a client side adapter of the calling source. The processing is thus finished. As for the answer message as well, the message conversion may be conducted as occasion demands.

(3) Form of System

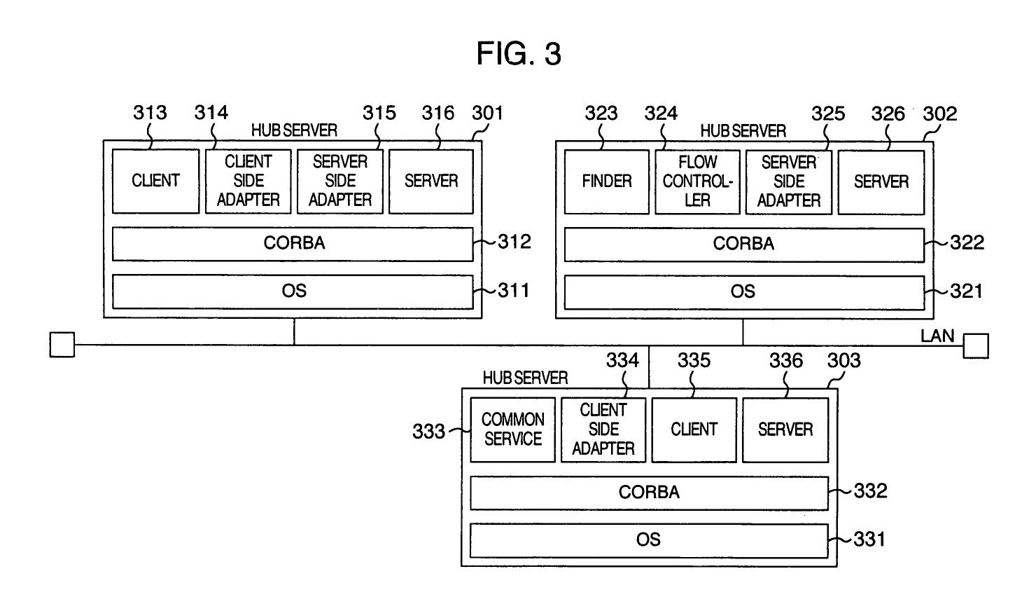

FIG. 3 shows a system configuration example of the hub in the present embodiment described with reference to FIGS. 1 and 2. Here, the hub is formed of three computers (hub servers) 301 to 303. Furthermore, servers and clients share the computers. (A server or client has a part of the hub function.)

On the hub servers 301 to 303, OSs (operating systems) 311, 321 and 331 and CORBAs 312, 322 and 332 are mounted. In the hub server 301, there are operating a client program 313, a client side adapter program 314, a server side adapter program 315, and a server program 316. In the hub server 302, there are operating a finder program 323, a flow control program 324, a server side adapter program 325, and a server program 326. In the hub server 303, there are operating a common service program 333, a client side adapter program 334, a client program 335, and a server program 336.

The client programs 313 and 335 are programs for implementing the client side systems described with reference to FIGS. 1 and 2. The client side adapter programs 314 and 334 are programs for implementing the client side adapters described with reference to FIGS. 1 and 2. The server side adapter programs 315 and 325 are programs for implementing the server side adapters described with reference to FIGS. 1 and 2. The server programs 316, 326, and 336 are programs for implementing the server side systems described with reference to FIGS. 1 and 2. The finder program 323 is a program for implementing the finder described with reference to FIGS. 1 and 2. The flow control program 324 is a program for implementing the flow controller described with reference to FIGS. 1 and 2. The common service program 333 is a program for implementing the common service described with reference to FIG. 2.

These programs operate on an appropriate number of computers connected by a LAN (local area network). In the case where the hub is formed of a plurality of computers, arbitrary programs can be made to operate on each computer. Furthermore, each program can be distributed in function to a plurality of computers on CORBA. The client programs 313 and 335 and the server programs 316, 326, and 336 are programs for conducting individual business processing, and they are not included in the hub. However, the clients and servers may be mounted on computers forming the hub. Therefore, such an example is shown in FIG. 3. Each of the clients and servers may have a specific terminal using special hardware.

As another example, the hub may be implemented by using one or more independent computers as shown in FIG. 1.

In any case, it is desirable to distribute the function of the hub so as not to concentrate the load on a part of computers and network lines.

1. An inter-system cooperative system, connected to a plurality of information systems, including a plurality of paths, for cooperatively operating the information systems using the paths to perform a plurality of businesses, comprising:
storage means for storing a path decision rule defining a path for performing each of the businesses,
message acceptation means for receiving a message relating to one of the plurality of businesses from a first information system in the information systems, the message including a business code identifying the one business and a control information indicative of a destination of the message;
path selection means for selecting one of the paths for performing the one business identified by the business code using the path decision rule;
system specifying means for specifying at least one second information system in the information systems as a message destination using the control information; and
message sending means for sending the message to the second information system via the selected path,
wherein the respective paths provide different functions relating to the message and one of the paths provides no function relating to the message.

2. The inter-system cooperative system according to claim 1, wherein the paths include a direct path and a normal path, the path selection means selects the normal path when the system specifying means specifies at least two information systems as the second information systems, and selects the direct path when the system specifying means specifies one information system as the second information system.

3. The inter-system cooperative system according to claim 2, further including flow control means for controlling a flow of the received message to provide a composite service as the business using a flow management, the flow control means being provided on the normal path as one of the functions.

4. The inter-system cooperative system according to claim 3, wherein the flow control means controls an order of a delivery of the message to the second information systems in response to the reception of the message.

5. The inter-system cooperative system according to claim 2, wherein the direct path includes an adapter direct connection path and a specific protocol direct connection path, protocol conversion means for converting a protocol of the message being provided on the adapter direct connection path as one of the functions, and the path selection means selecting the adapter direct connection path to convert the message when determining that protocol conversion is necessary for communicating between the first information system and the second information system by referring to the control information.

6. The inter-system cooperative system according to claim 2, wherein the business is a financial transaction, the path selection means selecting the direct path when the second information system is an accounting system and the business code is deposit or withdrawal of a savings account, and the path selection means selecting the normal path when the second information systems are an accounting system and an investment trust system and the business code is an application of a investment trust.

7. A method for cooperatively operating information systems using paths to perform a plurality of businesses, comprising:
storing a path decision rule defining a path for performing each of the businesses;
receiving a message relating to one of the plurality of businesses from a first information system in the information systems, the message including a business code identifying the one business and a control information indicative of a destination of the message;
selecting one of the paths for performing the one business identified by the business code using the path decision rule;
specifying at least one second information system in the information systems as a message destination using the control information; and
sending the message to the second information system via the selected path,
wherein the respective paths provide different functions relating to the message and one of the paths provides no function relating to the message.

8. The method according to claim 7, wherein the paths include a direct path and a normal path, the normal path being selected when at least two information systems are specified as the second information systems, and the direct path being selected when the one information system is specified as the second information system.

9. The method according to claim 8, further including controlling a flow of the received message to provide a composite service as the business using a flow management, the flow control being provided on the normal path as one of the functions.

10. The method according to claim 9, further comprising controlling an order of a delivery of the message to the second information systems in response to the reception of the message.

11. The method according to claim 8, wherein the direct path includes an adapter direct connection path and a specific protocol direct connection path, protocol conversion for converting a protocol of the message being provided on the adapter direct connection path as one of the functions, and selecting the adapter direct connection path to convert the message when determining that protocol conversion is necessary for communicating between the first information system and the second information system by referring to the control information.

12. The method according to claim 8, wherein the business is a financial transaction, and further comprising selecting the direct path when the second information system is an accounting system and the business code is deposit or withdrawal of a savings account, and selecting the normal path when the second information systems are an accounting system and an investment trust system and the business code is an application of a investment trust.

13. An apparatus comprising a storage medium with instructions stored therein for cooperatively operating information systems using paths to perform a plurality of businesses, the instructions when executed causing a processing device to perform:
storing a path decision rule defining a path for performing each of the businesses;
receiving a message relating to one of the plurality of businesses from a first information system in the information systems, the message including a business code identifying the one business and a control information indicative of a destination of the message;
selecting one of the paths for performing the one business identified by the business code using the path decision rule;
specifying at least one second information system in the information systems as a message destination using the control information; and
sending the message to the second information system via the selected path,
wherein the respective paths provide different functions relating to the message and one of the paths provides no function relating to the message.

14. The apparatus according to claim 13, wherein the paths include a direct path and a normal path, the normal path being selected when at least two information systems are specified as the second information systems, and the direct path being selected when the one information system is specified as the second information system.

15. The apparatus according to claim 14, further performing controlling a flow of the received message to provide a composite service as the business using a flow management, the flow control being provided on the normal path as one of the functions.

16. The apparatus according to claim 15, further performing controlling an order of a delivery of the message to the second information systems in response to the reception of the message.

17. The apparatus according to claim 14, wherein the direct path includes an adapter direct connection path and a specific protocol direct connection path, protocol conversion for converting a protocol of the message being provided on the adapter direct connection path as one of the functions, and selecting the adapter direct connection path to convert the message when determining that protocol conversion is necessary for communicating between the first information system and the second information system by referring to the control information.

18. The apparatus according to claim 14, wherein the business is a financial transaction, and further performing selecting the direct path when the second information system is an accounting system and the business code is deposit or withdrawal of a savings account, and selecting the normal path when the second information systems are an accounting system and an investment trust system and the business code is an application of a investment trust.
